(19) United States
(12) Patent Application Publication
(10) Pub. No.: US 2018/0129998 A1
(43) Pub. Date: May 10, 2018

(54) NETWORK CONNECTED PANTRY

(71) Applicant: International Business Machines Corporation, Armonk, NY (US)

(72) Inventors: Charlene K. Frazier, Durham, NC (US); Jonathan W. Jackson, Durham, NC (US); Jenay Y. Miller, Morrisville, NC (US); Robert D. Thompson, Cary, NC (US)

(21) Appl. No.: 15/348,124

(22) Filed: Nov. 10, 2016

(51) Int. Cl. G06Q 10/06; G06Q 10/08; G06Q 30/06; G06Q 50/12

(52) U.S. Cl. CPC G06Q 10/06315; G06Q 10/087; G06Q 50/12; G06Q 10/0832; G06Q 30/0637

(57) ABSTRACT

Smart-refrigerators are leveraged to communicate inventory with each other through a network within a region. Food not being used by one consumer may be used by another consumer in the region, enabling users in a community to minimize a community's food waste.

### BACKGROUND

The present invention relates to a network system, and more specifically to a network system of pantries or refrigerators where an exchange of food or other items can take place to aid reducing food or perishable waste.

There is a lot of food waste today. Consumers purchase food products or other items and may only need a portion of or consume a portion of the product before it expires or goes to waste.

An Internet refrigerator (also known as a smart refrigerator) is a refrigerator which has been programmed to sense what kinds of products are being stored inside it and keeps track of its stock through barcodes or RFID scanning, manual entry etc. This kind of refrigerator is often equipped to determine whenever a food item needs to be replenished or a food item may expire.

### SUMMARY

According to one embodiment of the present invention, a method of product exchange between at least two refrigerators connected to a network, each of the refrigerators comprising a computer is disclosed. The method comprising the steps of: a first computer of the first refrigerator receiving a query with specified criteria regarding a perishable product from a first user via an interface; if the perishable product is not available in the first refrigerator, the first computer accessing one or more second computers of other refrigerators and their perishable and associated inventories via a network; the first computer of the first refrigerator searching other refrigerators in the network for availability of the perishable product; if the perishable product is available from one or more inventories associated with second computers of other refrigerators within the network, the first computer determining whether the product available meets the specified criteria; the first computer querying the second device computer for approval of a purchase of the perishable product that fits the criteria and the query; the first computer receiving an acceptance of the exchange of the perishable product from the second computer; and the first computer sending a notification to the first user regarding the availability of the perishable item.

According to another embodiment of the present invention, a computer program product for product exchange between at least two refrigerators connected to a network is disclosed. Each of the refrigerators comprising a computer comprising at least one processor, one or more memories, one or more computer readable storage media, the computer program product comprising a computer readable storage medium having program instructions embodied therewith. The program instructions executable by the computer to perform a method comprising: receiving, by the first computer of the first refrigerator, a query with specified criteria regarding a perishable product from a first user via an interface; if the perishable product is not available in the first refrigerator, accessing, by the first computer of the first refrigerator, one or more second computers of other refrigerators, and their perishable and associated inventories via a network; searching, by the first computer of the first refrigerator, other refrigerators in the network for availability of the perishable product; if the perishable product is available from one or more inventories associated with second computers of other refrigerators within the network, determining, by the first computer of the first refrigerator, whether the product available meets the specified criteria; querying, by the first computer, the second device computer for approval of a purchase of the perishable product that fits the criteria and the query; receiving, by the first computer, an acceptance of the exchange of the perishable product from the second computer; and sending, by the first computer of the first refrigerator, a notification to the first user regarding the availability of the perishable item.

According to another embodiment of the present invention, a computer system for product exchange between at least two refrigerators connected to a network is disclosed. Each of the refrigerators comprising a computer comprising at least one processor, one or more memories, one or more computer readable storage media having program instructions executable by the computer to perform the program instructions. The program instructions comprising: receiving, by the first computer of the first refrigerator, a query with specified criteria regarding a perishable product from a first user via an interface; if the perishable product is not available in the first refrigerator, accessing, by the first computer of the first refrigerator, one or more second computers of other refrigerators, and their perishable and associated inventories via a network; searching, by the first computer of the first refrigerator, other refrigerators in the network for availability of the perishable product; if the perishable product is available from one or more inventories associated with second computers of other refrigerators within the network, determining, by the first computer of the first refrigerator, whether the product available meets the specified criteria; querying, by the first computer, the second device computer for approval of a purchase of the perishable product that fits the criteria and the query; receiving, by the first computer, an acceptance of the exchange of the perishable product from the second computer; and sending, by the first computer of the first refrigerator, a notification to the first user regarding the availability of the perishable item.

### BRIEF DESCRIPTION OF THE DRAWINGS

FIG. 1 depicts an exemplary diagram of a possible data processing environment in which illustrative embodiments may be implemented.

FIGS. 2A-2B show a flow diagram of a method of product exchange.

FIG. 3 depicts an exemplary diagram of a possible data processing environment in which illustrative embodiments may be implemented.

### DETAILED DESCRIPTION

In an embodiment of the present invention, smart-refrigerators are leveraged to communicate inventory with each other through a network within a region. Food not being used by one consumer may be used by another consumer in the region, enabling users in a neighborhood to minimize a community's food waste. In another embodiment, businesses, such as a pharmacy, doctor's office or restaurants could also share inventory amongst themselves to reduce waste. For example, a doctor's office could share inventory of refrigerated medicines in limited supply with another doctor's office owned by the same practice. Additionally, restaurants could share inventory of perishable items between stores in a locale.

For example, a first user is cooking buttermilk biscuits on Monday and the recipe calls for 1 cup of buttermilk from a four cup container. The first user now has three cups of buttermilk left over in the quart container that they purchased.

A second user, which could be a neighbor of the first user, is making buttermilk pancakes for brunch on Wednesday. Their recipe also calls for 1 cup of buttermilk. Instead of the second user going to the store and buying a quart of buttermilk, the second user queries a pantry network connecting smart refrigerators in their locale (for example their neighborhood) for excess buttermilk, avoiding spending money on an entire quart and preventing the first user from wasting the remainder of their buttermilk. Furthermore, since the refrigerators are connected, payment could be provided for this exchange of goods automatically. By offering the remainder of perishable items to others who need it, waste generation is avoided (by both parties who would have otherwise both bought a full quart and each wasted three cups of buttermilk), and when only smaller amounts of food are needed, money is saved by both parties (by the first user who receives payment for use of their extra buttermilk and by the second user that only has to pay for the buttermilk they need).

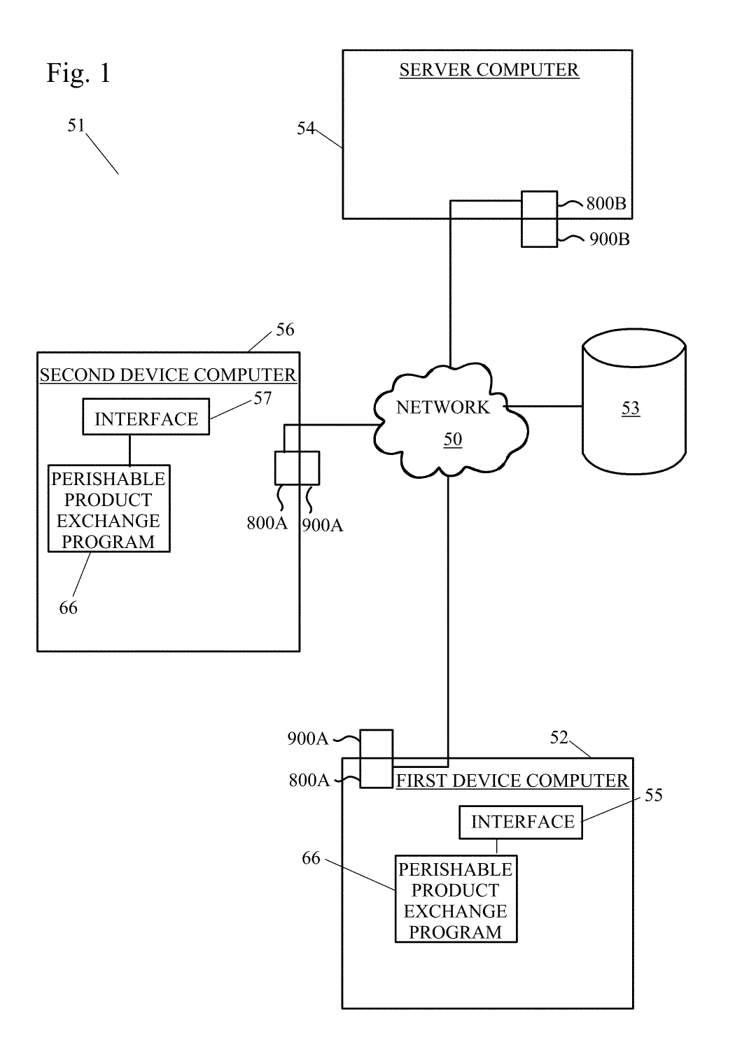

FIG. 1 is an exemplary diagram of a possible data processing environment provided in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Referring to FIG. 1, network data processing system 51 is a network of computers in which illustrative embodiments may be implemented. Network data processing system 51 contains network 50, which is the medium used to provide communication links between various devices and computers connected together within network data processing system 51. Network 50 may include connections, such as wire, wireless communication links, or fiber optic cables.

In the depicted example, a first device computer 52, a second device computer 56, a repository 53, and a server computer 54 connect to network 50. In other exemplary embodiments, network data processing system 51 may include additional client or device computers, storage devices or repositories, server computers, and other devices not shown.

The first device computer 52 and the second device computer 56 are preferably smart refrigerators. Other devices such as smart home devices may also make a query. The first and second device computers 52, 56 may contain an interface 55, 57 which may accept commands and data entry from a user. The commands may be: an entry of a query regarding what specific items in inventory are available for purchase by others and associated quantities, the expiration date of a product, information regarding the product, price of the remaining amount of product, recipe or ingredients needed for a recipe to be completed by a user and payment. The smart refrigerator may have sensors which provide feedback to the device computers 52, 56 to provide input regarding the stock of products being stored. The first and second device computers 52, 56 may additionally keep track of small amounts of excess perishables stored in locations such as a pantry, wine cellar, root cellar, etc. and may be entered manually by the user or through RFID scanning

A query provided by the user through the interface 55, 57 for small amounts of excess perishable food may also include food stored in locations other than the refrigerator, such as a pantry, freezer, wine cellar, root cellar, etc.

The interfaces 55, 57 of the device computers may also be used to allow a first smart refrigerator with a shopping list to attempt to source items from other refrigerators before adding items to a shopping list the user has to manually go out to purchase. The interfaces 55, 57 may additionally allow a neighboring smart refrigerator's inventories to be used in solutions that propose recipes based on food on hand. This could be very helpful for niche spices and other uses where small quantities of infrequently used ingredients are vital to a recipe. In an alternate embodiment, the interfaces 55, 57 may also be used with refrigerators in a doctor's office, where refrigerated medicines in limited supply may be shared in order to prevent excessive waste. In yet another embodiment, the interfaces 55, 57 may be used between multiple locations of a restaurant so that perishable inventory could be shared within a locale.

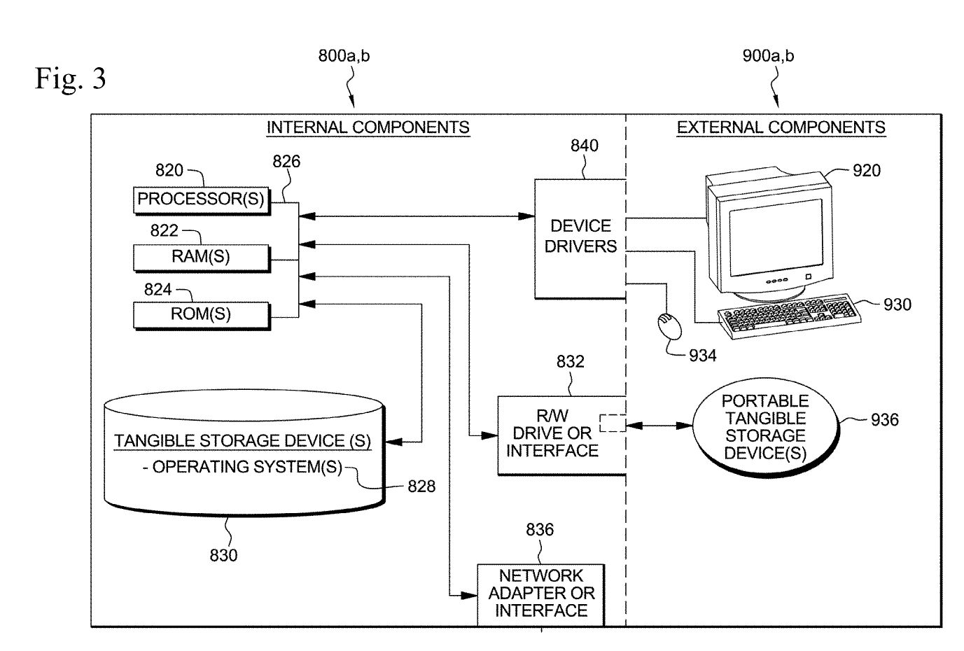

The interface 55, 57 can be, for example, a command line interface, a graphical user interface (GUI), a natural user interface (NUI) or a touch user interface (TUI). The first and second device computers 52, 56 each preferably includes a perishable product exchange program 66. While not shown, it may be desirable to have the perishable product exchange program 66 be present on the server computer 54. The first and second device computers 52, 56 each includes a set of internal components 800a and a set of external components 900a, further illustrated in FIG. 3.

Server computer 54 includes a set of internal components 800b and a set of external components 900b illustrated in FIG. 3. In the depicted example, server computer 54 provides information, such as boot files, operating system images, and applications to the first and second device computer 52, 56. Server computer 54 can compute the information locally or extract the information from other computers on network 50. The server computer 54 may also contain the perishable product exchange program 66.

It should be noted that while only two device computers 52, 56 are shown, multiple device computers may be present and networked together within a geographical region. For simplicity, only two device computers will be discussed within the application, however, the network may contain greater than two device computers.

Program code and programs such as perishable product exchange program 66 may be stored on at least one of one or more computer-readable tangible storage devices 830 shown in FIG. 3, on at least one of one or more portable computer-readable tangible storage devices 936 as shown in FIG. 3, or on storage unit 53 connected to network 50, or may be downloaded to a first device computer 52, a second device computer 56, or server computer 54, for use. For example, program code and programs such as perishable product exchange program 66 may be stored on at least one of one or more storage devices 830 on server computer 54 and downloaded to the first and second device computers 52, 56 over network 50 for use. Alternatively, server computer 54 can be a web server, and the program code, and programs such as perishable product exchange program 66 may be stored on at least one of the one or more storage devices 830 on server computer 54 and accessed by the first and second device computers 52, 56. In other exemplary embodiments, the program code, and programs such as perishable product exchange program 66 may be stored on at least one of one or more computer-readable storage devices 830 on first and second device computers 52, 56 or distributed between two or more servers.

In the depicted example, network data processing system 51 is the Internet with network 50 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 51 also may be implemented as a number of different types of networks, such as, for example, an intranet, local area network (LAN), or a wide area network (WAN). FIG. 1 is intended as an example, and not as an architectural limitation, for the different illustrative embodiments.

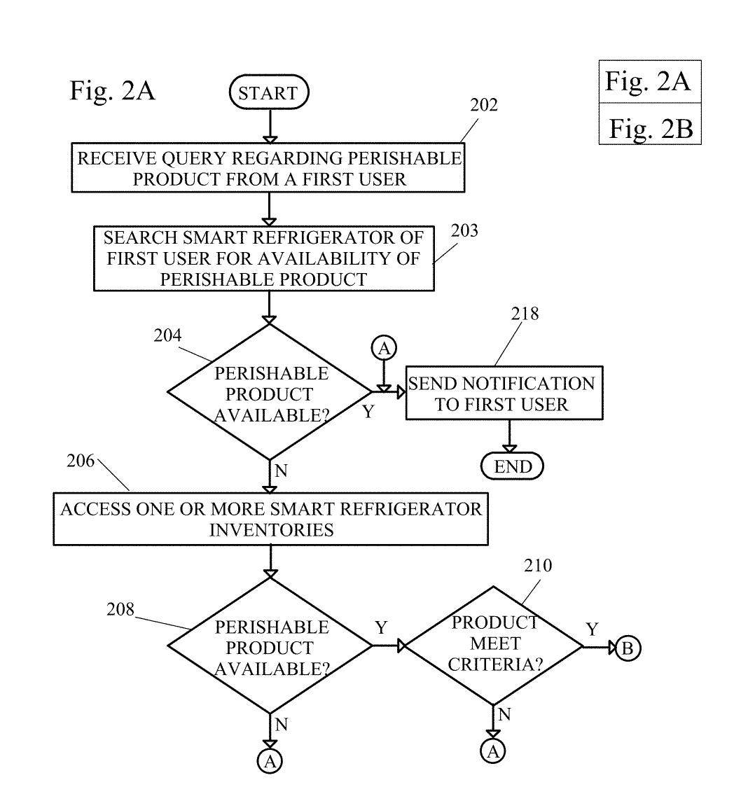

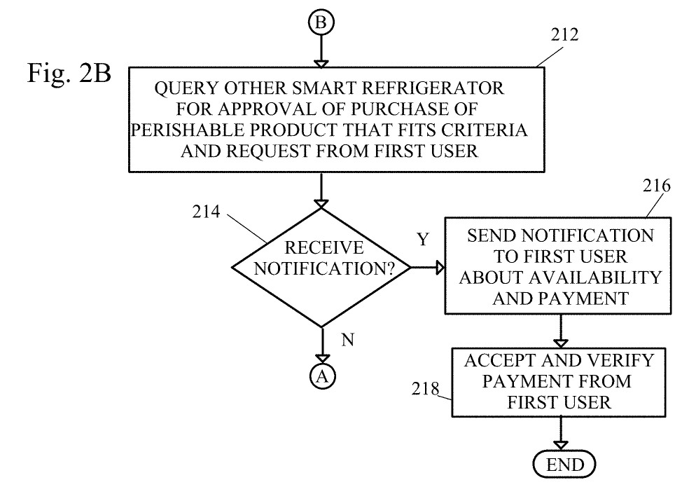

FIGS. 2A-2B show a flow diagram of a method of product exchange.

In a first step, a product exchange program 66 of a first device computer 52 receives a query regarding a perishable product from a first user via the interface 55 (step 202). The query may be regarding ingredients on hand. The ingredients may be to satisfy a recipe, a shopping list, or to fulfill a need of the first user. The query may include specific criteria for the item(s) being searched for. The criteria may include, but is not limited to: expiration date, brand, cost, amount, range from current address or home address willing to travel for pickup and storage temperature. The criteria may be set by the user or dictated by the recipe(s) being fulfilled.

The product exchange program 66 searches within a smart refrigerator associated with the first device computer 53 for availability of the perishable product (step 203).

If the perishable product or item is available within the smart refrigerator associated with the first device computer 52 or associated inventory (step 204), a notification is sent to the first user via the first device computer 52 (step 218) and the method ends. It should be noted that the associated inventory (inventory not directly present within the smart refrigerator) may include, but is not limited to the pantry, freezer, root cellar, or wine cellar.

If the perishable product is not available within the smart refrigerator or the associated inventory, (step 204), the product exchange program 66 accesses one or more device computers and their perishable and associated inventories via a network (step 206). The device computers are preferably within a set geographic area or distance from each other, for example 15miles or less. The geographic area may be set as criteria by the first user or set by an administrator. Other criteria may also be used to establish the range, such as estimated travel time, whether the location for pickup is within walking distance, or whether the route to be traveled for picking up an item would involve traveling on main roads as opposed to side streets or streets within an established neighborhood.

If the item is not available from one or more inventories associated with device computers in the network and within the geographic area (step 208), a notification is sent to the user via the first device computer 52 (step 218) and the method ends.

If the item is available from one or more inventories associated with device computers within the network (step 208), the product exchange program determines whether the item available meets specific criteria set by the first user (step 210). The criteria may include, but is not limited to: expiration data, amount, brand, cost and storage temperature. The criteria may be set by the first user or may be dictated by the recipe the first user is attempting to make.

If the criteria of the perishable product does not match the criteria being required by the first user (step 210), a notification is sent to the first user through the first device computer 52 (step 218) and the method ends. In an alternate embodiment, the first user can respond to the first device computer, accepting the perishable product even though the criteria doesn't match or meet the criteria and the method would continue to step 212.

If the criteria of the perishable product does match the criteria being required by the first user (step 210), the product exchange program 66 queries the second device computer for approval of a purchase of the perishable product that fits the criteria and request from the first user (step 212).

If the product exchange program 66 receives a notification from the second device computer 56 that the second user accepts the request or exchange of the perishable item (step 214), a notification is sent to the first user regarding the availability of the perishable item to the first user and for payment for the item (step 216). The notification may additional include the address or place of pickup of the product. Alternatively, the address for pickup of the product may be sent after the payment has been verified in step 218.

If the first user does not receive a notification regarding the product within a specific time period (step 214), a notification is sent to the first user through the first device computer 52 (step 218) regarding a lack of response for the product and the method ends. Alternatively, the method could repeat from step 212 for search for the same product from a different user.

The product exchange program 66 accepts and verifies the payment for the item (step 218) and the method ends. The product exchange program 66 could also remove the item the first user purchased from the inventory associated with the second device computer 56. If there is a problem with the payment, the method will end and a notification sent to the first and second users via the device computers 52, 56.

For example, a first smart refrigerator as well as existing pantry inventory is connected to other smart refrigerators and their existing pantries via a network. All of the smart refrigerators which are connected together via the network are within a specific geographic area, such as within 10 miles of each other.

A second user decides to make buttermilk biscuits via a recipe. The second user's smart refrigerator indicates that they have flour, butter and baking powder on hand and available, but no buttermilk. The recipe calls for one cup of buttermilk.

The second user's refrigerator queries all available smart refrigerators in the neighborhood to see if any of them have one cup of buttermilk available. Additional criteria such as price, brand and expiration date may be included in the query.

If buttermilk is available within someone else's smart refrigerator, for example a first user, information regarding the buttermilk is discovered and compared to criteria set by the second user's. The criteria may be set specifically by the second user or by the recipe being used by the second user. The criteria could be the temperature of refrigerator, distance from user's home, brand, price, and proximity to expiration date.

If any inventory meets all the criteria set by the second user, then the first user is prompted to accept the second user's request of ingredient (one cup of buttermilk).

If the first user accepts the product request, the second user is dispatched to obtain the ingredient (one cup of buttermilk) by a notification. The notification includes information regarding where to pick up the ingredient. Optionally, payment could be exchanged between user's accounts prior to the second user picking up the product.

Alternatively, if the buttermilk of the first user doesn't meet the criteria set by the second user, not the preferred brand, a notification may be sent to the first user allowing the first user to override the mismatch of criteria.

In another example, a patient is prescribed a refrigerated drug by a first doctor's office of a practice. However, the first doctor's office or their associated pharmacy does not have all of the refrigerated ingredients or the medicine to provide to the patient.

The first doctor's office, instead of buying more ingredients to make the patient's drug, queries other smart refrigerators of doctor's offices within the same practice or pharmacy company for the ingredients or the drug itself. Additional criteria such as price, brand and expiration date may be included in the query.

If ingredients or a drug is available within a second doctor's office's (or pharmacy) smart refrigerator, information regarding the ingredients or drug is discovered and compared to criteria set by the first doctor's office. The criteria (e.g. generic vs. name brand) may be set specifically by individuals in the doctor's office, by the patient or by the recipe being used to make the drug. The criteria could be the temperature of refrigerator, distance from doctor's office, brand, price, and proximity to expiration date.

If any inventory meets all the criteria set by the first doctor's office, then the first doctor's office, which made the request, is prompted to accept the request of ingredient or drug.

If the product request is accepted, the first doctor's office is dispatched to obtain the ingredient or drug. The acceptance of the product request may also include the address for pickup of the product. Optionally, payment could be exchanged between user's accounts prior to the first doctor's office picking up the ingredient or the drug.

Alternatively, if the ingredients or drugs don't meet the criteria set by the first doctor's office making the request, for example the request is for a generic drug or ingredient and only the name brand is available, a notification may be sent to the first doctor's office allowing the first doctor's office to override the mismatch of criteria.

FIG. 3 illustrates internal and external components of a first device computer 52, a second device computer 56, and server computer 54 in which illustrative embodiments may be implemented. In FIG. 3, a first device computer 52, a second device computer 56 and a server computer 54 include respective sets of internal components 800a, 800b and external components 900a, 900b. Each of the sets of internal components 800a, 800b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and product exchange program 66 are stored on one or more of the computer-readable tangible storage devices 830 for execution by one or more of the processors 820 via one or more of the RAMs 822 (which typically include cache memory). In the embodiment illustrated in FIG. 3, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, 800b also includes a R/W drive or interface 832 to read from and write to one or more portable computer-readable tangible storage devices 936 such as a CD-ROM, DVD, memory stick, magnetic tape, magnetic disk, optical disk or semiconductor storage device product exchange program 66 can be stored on one or more of the portable computer-readable tangible storage devices 936, read via R/W drive or interface 832 and loaded into hard drive 830.

Each set of internal components 800a, 800b also includes a network adapter or interface 836 such as a TCP/IP adapter card. Product exchange program 66 can be downloaded to the first device computer 52, the second device computer 56, and server computer 54 from an external computer via a network (for example, the Internet, a local area network or other, wide area network) and network adapter or interface 836. From the network adapter or interface 836, product exchange program 66 is loaded into hard drive 830. Product exchange program 66 can be downloaded to the server computer 54 from an external computer via a network (for example, the Internet, a local area network or other, wide area network) and network adapter or interface 836. From the network adapter or interface 836, context program 66 is loaded into hard drive 830. The network may comprise copper wires, optical fibers, wireless transmission, routers, firewalls, switches, gateway computers and/or edge servers.

Each of the sets of external components 900a, 900b includes a computer display monitor 920, a keyboard 930, and a computer mouse 934. Each of the sets of internal components 800a, 800b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

Product exchange program 66 can be written in various programming languages including low-level, high-level, object-oriented or non object-oriented languages.

Alternatively, the functions of a product exchange program 66 can be implemented in whole or in part by computer circuits and other hardware (not shown).

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method of product exchange between at least two refrigerators connected to a network, each of the refrigerators comprising a computer, the method comprising the steps of:
a first computer of the first refrigerator receiving a query with specified criteria regarding a perishable product from a first user via an interface;
if the perishable product is not available in the first refrigerator, the first computer accessing one or more second computers of other refrigerators and their perishable and associated inventories via a network;
the first computer of the first refrigerator searching other refrigerators in the network for availability of the perishable product;
if the perishable product is available from one or more inventories associated with second computers of other refrigerators within the network, the first computer determining whether the product available meets the specified criteria;
the first computer querying the second device computer for approval of a purchase of the perishable product that fits the criteria and the query;
the first computer receiving an acceptance of the exchange of the perishable product from the second computer; and
the first computer sending a notification to the first user regarding the availability of the perishable item.

2. The method of claim 1, wherein the specified criteria is selected from the group consisting of: expiration date, brand, cost, amount, and storage temperature.

3. The method of claim 2, wherein the criteria is dictated by a recipe.

4. The method of claim 2, wherein the criteria is set by the first user.

5. The method of claim 1, wherein the refrigerators are smart refrigerators.

6. The method of claim 1, wherein the perishable item is partially used.

7. The method of claim 1, wherein the exchange of the perishable item requires payment.

8. The method of claim 1, wherein the notification includes an address for pickup of the perishable product.

9. A computer program product for product exchange between at least two refrigerators connected to a network, each of the refrigerators comprising a computer comprising at least one processor, one or more memories, one or more computer readable storage media, the computer program product comprising a computer readable storage medium having program instructions embodied therewith, the program instructions executable by the computer to perform a method comprising:
receiving, by the first computer of the first refrigerator, a query with specified criteria regarding a perishable product from a first user via an interface;
if the perishable product is not available in the first refrigerator, accessing, by the first computer of the first refrigerator, one or more second computers of other refrigerators, and their perishable and associated inventories via a network;
searching, by the first computer of the first refrigerator, other refrigerators in the network for availability of the perishable product;
if the perishable product is available from one or more inventories associated with second computers of other refrigerators within the network, determining, by the first computer of the first refrigerator, whether the product available meets the specified criteria;
querying, by the first computer, the second device computer for approval of a purchase of the perishable product that fits the criteria and the query;
receiving, by the first computer, an acceptance of the exchange of the perishable product from the second computer; and
sending, by the first computer of the first refrigerator, a notification to the first user regarding the availability of the perishable item.

10. The computer program product of claim 9, wherein the specified criteria is selected from the group consisting of: expiration date, brand, cost, amount, and storage temperature.

11. The computer program product of claim 10, wherein the criteria is dictated by a recipe.

12. The computer program product of claim 10, wherein the criteria is set by the first user.

13. The computer program product of claim 9, wherein the perishable item is partially used.

14. The computer program product of claim 9, wherein the notification includes an address for pickup of the perishable product.

15. A computer system for product exchange between at least two refrigerators connected to a network, each of the refrigerators comprising a computer comprising at least one processor, one or more memories, one or more computer readable storage media having program instructions executable by the computer to perform the program instructions comprising:
receiving, by the first computer of the first refrigerator, a query with specified criteria regarding a perishable product from a first user via an interface;
if the perishable product is not available in the first refrigerator, accessing, by the first computer of the first refrigerator, one or more second computers of other refrigerators, and their perishable and associated inventories via a network;
searching, by the first computer of the first refrigerator, other refrigerators in the network for availability of the perishable product;
if the perishable product is available from one or more inventories associated with second computers of other refrigerators within the network, determining, by the first computer of the first refrigerator, whether the product available meets the specified criteria;
querying, by the first computer, the second device computer for approval of a purchase of the perishable product that fits the criteria and the query;
receiving, by the first computer, an acceptance of the exchange of the perishable product from the second computer; and
sending, by the first computer of the first refrigerator, a notification to the first user regarding the availability of the perishable item.

16. The computer system of claim 15, wherein the specified criteria is selected from the group consisting of: expiration date, brand, cost, amount, and storage temperature.

17. The computer system of claim 16, wherein the criteria is dictated by a recipe.

18. The computer system of claim 16, wherein the criteria is set by the first user.

19. The computer system of claim 15, wherein the perishable item is partially used.

20. The computer system of claim 15, wherein the notification includes an address for pickup of the perishable product.
